(19) United States
(12) Patent Application Publication
(10) Pub. No.: US 2026/0062820 A1
(43) Pub. Date: Mar. 5, 2026

(54) ELECTROLYSER UNIT COMPRISING A PLURALITY OF INDIVIDUAL ELECTROLYSER STACKS AND METHOD FOR CONNECTING ELECTROLYSER STACKS TO FORM UNITS

(71) Applicant: GREEN HYDROGEN SYSTEMS A/S, Kolding (DK)

(72) Inventors: Anders RØNNE RASMUSSEN, Kolding (DK); Henrik GØBEL FÜCHTBAUER, Kolding (DK); Søren HADBERG, Kolding (DK); Anders NYGAARD LAURIDSEN, Kolding (DK)

(21) Appl. No.: 19/473,078

(22) PCT Filed: Feb. 16, 2024
(86) PCT No.: PCT/EP2024/054051

§ 371 Date: Oct. 6, 2025

(30) Foreign Application Priority Data
Feb. 17, 2023 (DK) PA202300143

(51) Int. Cl. C25B 9/77; C25B 9/65; C25B 15/08

(52) U.S. Cl. CPC C25B 9/77; C25B 9/65; C25B 15/083

(57) ABSTRACT

In a method for connecting a pair of electrolyser stacks with electrolyte, electric current and gas drain piping, each pair of stacks of the electrolyser: through interconnection endplates are supplied with alkaline electrolyte at elevated pressure by common electrolyte supply pipes and further, through the interconnection endplate drain off oxygen gas containing electrolyte, and hydrogen gas containing electrolyte, to common gas separation vessels for oxygen and hydrogen respectively, pull first electrically interconnected current injection electrodes adjacent to interconnection endplates to zero electrical potential through a zero potential conductor, and supply second current injection electrodes placed adjacent to distal endplates with electric current at potentials equally higher and lower respectively than the zero potential at the first electrodes.

The present invention relates to an electrolyser unit comprising a plurality of individual electrolyser stacks. The present invention further relates to a method for connecting electrolyser stacks to form units. More particularly, the present invention relates to a method for supplying pairs of electrolyser stacks with alkaline electrolyte, electric current and gas drain piping.

### BACKGROUND OF THE INVENTION

In pressurised alkaline electrolysers for producing hydrogen and oxygen, usually a series of cells are arranged in a stack and the alkaline electrolyte is supplied to the cells through electrolyte manifolds.

Each cell has an anodic and a cathodic flow and process chamber. A bipolar plate forms the partition between anodic and cathodic flow chambers in consecutive cells, such that a first side of the bipolar plate will reside in a cathodic flow chamber of a cell, and an opposed side of the bipolar plate will reside in the anodic flow chamber of an adjacent cell. The produced gasses, oxygen and hydrogen, are kept separated via a diaphragm arranged between cathodic and anodic process flow chambers.

The cells are filled with electrolyte based on water with an alkaline substance dissolved therein. During electrolysis, the electrolyte or lye will gradually fill with gas, which will form bubbles as the hydrogen is released at the cathode by the cathodic side of the bipolar plate (negative pole) and oxygen is released at the anode by the anodic side of the bipolar plate (positive pole). The electrolyte is often a KOH based lye, but other alkaline substances may be used.

The electrical DC potential difference between a negative and a positive electric current injection electrode at each end of a cell stack drives the electric current through the intermediate cells, whereby the current alternately runs in the bipolar plate and electrodes and in the electrolyte between alternating cathode and anode pairs and provokes the anode side and cathode side processes.

Electrolyte or lye is used as common names for anolyte and catholyte.

Each cell has two fluid flow inlets, one for the oxygen lye or anolyte and one for the hydrogen lye or catholyte. The fluid inlets to the cell connect respectively electrolyte or lye manifolds to the cathode and anode. The cathode chamber is also connected to a hydrogen evacuation channel and the anode chamber is connected to an oxygen evacuation channel. When the cells are combined into a stack, four long stack internal channels or manifolds are provided, and all four are connected to each their fitting in an endplate for piping connections. The four manifolds are: one oxygen evacuation channel, one hydrogen evacuation channel, one oxygen lye or anolyte supply channel, and one hydrogen lye or catholyte supply channel.

A mixture of gas and electrolyte flows from the stack to separator vessels via the two evacuation channels as the oxygen and hydrogen evacuation channels will inevitably comprise a mixture of electrolyte and the produced gas. In the separators, gas will migrate out of the lye, and accumulate above the fluid phase lye, while the lye accumulates in the lower part of the separators.

The electrolyte is pumped from an outlet in each separator and back into the respective electrolyte manifold channels of the stack. Thereby, lye from the hydrogen separator is pumped back to the manifold serving the cathodes, and lye from the oxygen separators is pumped back into the manifold serving the anodes in the cell stack. Water may be added to these lye streams, so that water consumed in the electrolysis process is replenished continually. The temperature of the electrolyte may also be regulated by passing each of the two electrolytes through heat exchangers.

Electrolyser stacks of the above kind are well known in the art. The heat generated in both stack internal lye manifolds due to electric current flows therein and between the cathode and anode pairs does not contribute to the electrolysation of the water, and this heat must eventually be extracted from the lye and represents a loss. It is thus desirable to keep the generation of heat as small as possible. Any measure that will keep the electric current running in the lye channels low is instrumental in keeping the heat generation low.

At the same time, the flow channels which add the electrolyte to the cathode and anode parts of each cell should generate as little flow resistance as possible as otherwise the energy used in pumping the liquid into each manifold also increases excessively, as does the challenge of keeping an equal flow of electrolyte into each cell. A flow resistance is preferably provided at inflow paths between lye manifold and each half cell, ensuring that each half cell coupled to a manifold receive lye at equal pressures.

### SUMMARY OF THE INVENTION

In order to overcome the above challenges, and to provide further benefits, in a first aspect of the invention, an electrolyser unit is provided comprising a plurality of individual electrolyser stacks, wherein each individual electrolyser stack has a series of cell circumferential cell frames. The circumferential cell frames are adapted to be urged against each other between an interconnection endplate and an opposed distal endplate, wherein each cell comprises:
a diaphragm spanning the cell frame,
electrodes,
a catholyte flow channel,
an anolyte flow channel,
a catholyte and hydrogen evacuation channel, and
an anolyte and oxygen evacuation channel,
   wherein the cell frames are adapted to secure the alkaline electrolyte and gasses within the cell under elevated pressure when pressed against adjacent circumferential cell frames, and
   wherein the interconnection endplate of each individual cell stack comprises:
an axially through-going hydrogen gas and electrolyte connection which is in fluid communication with a hydrogen separation vessel and an axially through-going oxygen gas and electrolyte connection which is in fluid communication with an oxygen separation vessel, and
axially through-going electrolyte flow channels which are in fluid communication with electrolyte pumps.

In order to gain the aforementioned benefits, at least a pair of electrolyser stacks are provided and arranged pairwise side by side and in each pair of stacks, first current injection electrodes in cells at the interconnection endplates are electrically interconnected and connected to a common electrical zero potential and second current injection electrodes placed at the distal endplates, are connected to electric current sources at potentials equally higher and lower than the electrical zero potential realised at the electrodes at the interconnection endplates, and further pairs of stacks are connected to common hydrogen and oxygen separation vessels and electrolyte supply pumps through their interconnection endplates.

By this construction, the two stacks in a pair are both served with lye through connections and have gas extraction pipe connections running axially through only the one endplate of each stack where the electrical potential is zero or close to zero. Thereby the pipes and connections for the two stacks are uncharged, or close to uncharged. As the lye running in such pipes is electrically conductive, this lye should ideally be kept uncharged to avoid the presence of electric charges or electric currents at un-expected locations in the plant. Further, by the provision of two stacks and the supply of the current to them at potentials equally higher and lover than the zero potential at the two interconnection endplates, it is ensured that the number of cells is kept as small as possible given a predefined cell area and predefined current consumption in each cell and an electrolyte supply channel diameter. It is noted that the diameter of the electrolyte supply manifolds must go up as the number of cells increase in order to keep uniform flow into all cells in a stack, and as the electrolyte supply channel diameter increases, so does the unwanted currents which leads to the generation of ohmic heat in the electrolyte manifolds in each stack. Preferably an insulation plate shall reside between each endplate and the current injection plate at the respective endplate. Thus, the endplates are electrically insulated from the current injection plate at their vicinity.

In an embodiment the interconnection end plates of a stack pair or of a multitude of stack pairs are arrange adjacent to a common vertical plane and immovably locked to support tracks, and further, the distal endplates are movably attached to the support tracks to allow the distal endplate a degree of movement in the length axis direction of the stack it belongs to.

As the stacks are heated and pressurised, they also undergo small amounts of elongation, which will mechanically stress electric and fluid connection points, however having the interconnection end plates fixed with respect to stack-axial movement allows any connection to the interconnection end plates to remain unaffected by the elongation. As the distal endplates are only mechanically connected to the high potential or low potential electric current supply leads, which are more flexible and resilient than the piping, they will easily move with the heat and pressure induced movements of the distal endplates. The tracks are preferably provided below each stack but may in principle alternatively be provided above the stacks. The construction allows for no use of flexible hoses, and as such are often lacking in durability and leek-tightness, the exclusive use of metal pipes allows a more secure high pressure hydrogen generating plant with a multitude of stacks to be realized. It is also mentioned that the electric connection between the current injection electrodes residing adjacent the interconnection endplates becomes very simple, and may well comprise no more than a simple fish plate like metal piece, bolted onto extensions of the two current injection electrodes. This is possible both because of the arrest of movement in the axial direction of the current injection plates and their close proximity to each other. The connection also lends itself handily as a place of electric current measurement in case the electric current flowing between the stacks needs to be measured and observed.

If each stack comprises between 150 and 250 cells, it will be possible to establish a reasonable DC potential difference between current injection plates equally below and above the zero potential current injection plates at the interconnection endplates. This may be achieved using well known power supply potential realisable from usual power grids.

In such an arrangement, individual stack pairs of the multitude of pairs may be powered down without regard to the effects on the gas separation vessels.

In an embodiment at least one of a voltage measurement device adapted to capture the voltage signal V over each stack and a current measurement device adapted to capture the current signal A in each ground connection lead are arranged such that at least one of the current A and the voltage V are captured and stored regularly during electrolysation.

With this embodiment any significant change of stack function in each stack may be detected timely and operational changes such as shut down of the plant or a partial shut down of a stack pair may be instigated, thereby ensuring the integrity of the plant.

In an embodiment, each pair of stacks in a multitude of stack pairs have a dedicated current supply module. In yet another embodiment, a multitude of stacks share a common current supply module.

The possible individual regulation of current supply to stack pairs is advantageous as it allows for current consumption regulation for the multitude of stacks, possibly leaving some pairs of the stacks with little or no current supply depending on the availability of electric power or the condition of a particular stack pair. This is possible due to the common zero potential for all stacks. This common zero potential is applied even as the stacks are also interconnected through the piping between each stack and the gas separation vessels and lye pump connections.

If the stack pairs have a common power supply module, they may be regulated together up and down in power consumption. The possibility of both of the above power supply options ensures an enhanced flexibility when a plant shall be adapted to local conditions.

In an embodiment, a power transformer is adapted to supply power to each of three pairs of stacks by firstly splitting a three-phase electric AC grid line input into three identical three phase output AC power supply lines. Secondly three AC to DC converters are arranged in connection with and connected to each its own AC output line to convert each of the three-phase output AC line power supply into three corresponding DC high potential and low potential lines. And thirdly, the high potential output and low potential output of each DC line output is arranged to connect the respective second ones of the two current injection electrodes placed at distal endplates of each stack of the pair of stacks while electrically interconnecting each of the current injection electrodes at the interconnection endplates by interconnection leads at each pair of stacks and also grounding these interconnections through individual and separate grounding points at each pair of interconnected current injection electrodes.

The power supply to each of the three stack pairs is galvanic isolated and may in principle feed each pair of stacks independently. However, it is preferred to feed the three stack pairs in unison. Three electric switches are provided to this end between the power converter output lines and the AC/DC input terminals to allow connection and dis-connection of the power. The provided power supply is robust as also the minor deviations in the electric properties of the two stacks in each pair of stacks, and minor differences of the stack resistance will not cause major problems. Also, any irregularity may easily be detected by surveillance of either or both of electric current flow to ground and the voltage losses over each stack in stack pairs.

In a second aspect, the objects of the invention are achieved by a method for supplying pairs of electrolyser stacks with alkaline electrolyte, electric current and gas drain piping. According to the invention, each pair of electrolyser stacks further:
through interconnection end plates are supplied with alkaline electrolyte at elevated pressure by common electrolyte supply pipes and further,
through the interconnection endplate drains off oxygen gas containing electrolyte, and hydrogen gas containing electrolyte, to gas separation vessels for oxygen and hydrogen respectively,
pull first electrically interconnected current injection electrodes adjacent to interconnection endplates to zero electrical potential through a zero potential conductor, and
supply second current injection electrodes placed adjacent distal endplates with electric current at potentials equally higher and lower respectively than the zero potential at the first electrodes.

By the method, it is ensured that the connection between the electrolyser stacks and recipients and suppliers of substances to/from the stack are not adversely affected by the electrical potentials residing inside the stack. Known adverse effects are corrosion and hazards to personnel working at the stacks. It is also ensured, that the electric currents running in the lye supply manifolds is kept as small as possible, as the number of cells between the interconnection endplates and distal endplates is kept low while the overall electrical potential between two distally placed current injection electrodes in a given stack pair remains substantial.

In an embodiment, interconnection endplates of a pair of stacks during use are urged towards respective distal endplates through a number of pull rods attached to the interconnection endplates and the distal endplates respectively and arranged externally to perimeters of the cell frames in each stack, such that cell frames of cells between the interconnection endplates and the distal endplates are pressed towards each other.

Through this construction, it is ensured that a constant pressure may be sustained through cycles of heating from working temperature and down to ambient temperatures. Any creeping of the cell frames, which may take place over the years may easily be accommodated by the pull rods. This may be achieved by adding/subtracting to the pull force of the pull rods, such as by supplying pull rods with threads, running the threaded pull rods through corresponding holes in the outer regions of the endplates and adding nuts to the threads distally from one or both endplates. By tightening the nuts against the endplates, the pressure force on the cell frames may be regulated according to need as known in the art. A disc spring stack may be supplied between the nuts and the endplates to further ensure uniform pulling forces between corresponding endplates during use of the cell stack. It is also possible to provide a mirror force ring externally of the cells and placed in a midplane between the endplates. Pull rods are here supplied between the ring and the endplates, whereby the stacks of disc springs may reside with the mirror ring and not protrude lengthwise away from the endplates. This leaves the endplates with more workspace adjacently to the end surfaces thereof and keeps the stack building length low.

In an embodiment, a multitude of electrolyser pairs are supplied with electric current from each their current supply device or through a common current supply device. The flexibility, which the mentioned two alternative embodiments of the invention provides, allows for local adaptations.

In an embodiment, an anolyte pump supplies anolyte drained from the oxygen separation vessel to respective anolyte endplate connections of each stack through anolyte stack external supply lines and further a catholyte pump supplies catholyte drained from the hydrogen separation vessel to respective catholyte endplate connections of each stack through catholyte stack external supply lines.

The pump allows for the use of small diameters of the stack internal manifolds which leads the flow of electrolyte to the cells. The reduced diameters of the manifolds inside the stacks aids in keeping stray currents low in these channels.

In an embodiment of the method, interconnection end plates of a stack pair or of a multitude of stack pairs are arrange adjacent to a common vertical plane and are immovably locked to support tracks, and further the distal endplates are movably supported by the tracks to allow the distal endplates a degree of movement in the length axis direction of respective stack.

This embodiment allows supply of fluids through pipe connections running axially through the interconnection end plates, since these plates remain un-affected by the elongations induced by pressure or temperature changes. Thus, lunger stacks may be built, and higher pressurizations are allowed, as the electric leads connecting the distal end plate current injection electrodes may easily absorb the dimensional changes, which the pipes and especially pipe connections are not designed to absorb. It is also to be noticed, that the electric lead between the current injection electrodes at the interconnection end plates can be made essentially stiff as very little movement will be observed between stack pair interconnection end plates, and their corresponding current injection electrodes.

Preferably the multitude of pairs of stacks are arranged side by side, however it is also an option to build vertical stack arrays, where stack pairs are arranged one above the other. In such an arrangement, preferably all stack to be supplied with a low potential DC current shall be vertically aligned above each other and each sit horizontally aligned with a stack adapted to receive the low potential DC electric current. DC current supply to such a vertical array of stack pairs becomes very simple, as all low potential current connections will be vertically aligned, as will all high potential current connections. Combinations of vertically and horizontally arranged arrays of stack pairs are also possible, however still with all interconnection end plates arranged and immobilized in one and the same vertical plane.

In an embodiment, a power transformer supplies power to each of three pairs of stacks by firstly splitting a three-phase electric AC grid line power input into three individual three phases, and secondly converting each set of three phases into three corresponding DC high potential and low potential supplies in separate AC to DC converters. Thirdly, a high potential output power supply and low potential output power supply of each DC line output is directed to the respective second ones of the two current injection electrodes placed at distal endplates of each stack of the pair of stacks. At the same time, ach of the current injection electrodes at the interconnection endplates are electrically interconnected and these electrical interconnections are balanced through separate grounding points.

By this method, a simple and efficient power supply to pairs of cell stacks is ensured.

In an embodiment at least one of a voltage measurement device adapted to capture the voltage signal V over each stack and a current measurement device adapted to capture the current signal A in each ground connection lead at a stack pair zero potential interconnection are arranged such that at least one of a current signal A and a voltage signal V are captured and stored regularly during electrolysation.

By these measures, it is possible to monitor the wear of each stack and stack pair, and also it becomes possible to identify possible malfunctions, such that a given stack pair may be powered down in order to avoid that a minor malfunction develops further within a stack.

Various exemplifying and non-limiting embodiments both as to constructions and to methods of operation, together with additional objects and advantages thereof, will be best understood from the following description of specific exemplifying and non-limiting embodiments when read in conjunction with the accompanying drawings. The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1 is a schematic representation of an embodiment of the invention,

FIG. 2 is a schematic representation of the cell structure within a stack,

FIG. 3 is a 3D representation of a sectional view of an electrolyser stack,

FIG. 4 is a schematic representation of an electrolyser unit 47 wherein the power supply is shown,

FIG. 5 shows 3 pairs of stacks in a side-by-side configuration,

FIG. 6 shows a 3D representation of a low potential end of a stack pair,

FIG. 7 shows a further 3D representation of the two outermost stacks in FIG. 5, including the stack external manifold piping and parts of the two separators,

FIG. 8 shows a further way of arranging an array of stack pairs, and

FIG. 9 is an enlarged sectional 3D representation of a detail from FIG. 7.

### DETAILED DESCRIPTION OF THE EMBODIMENTS

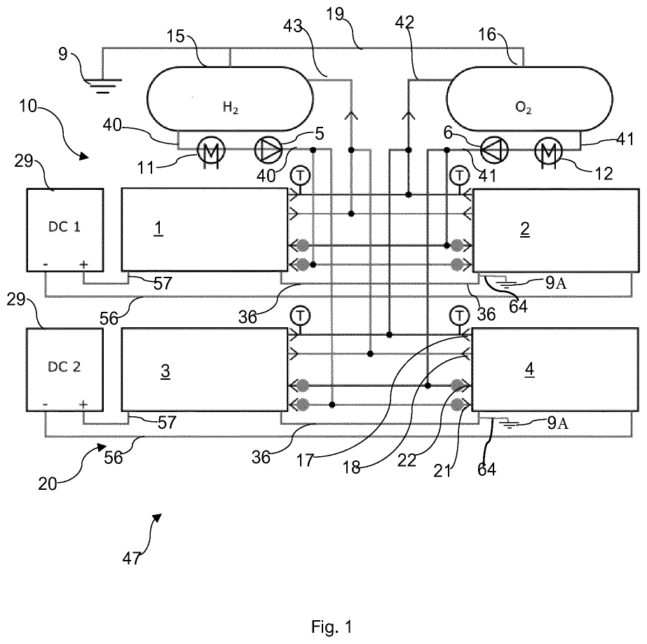

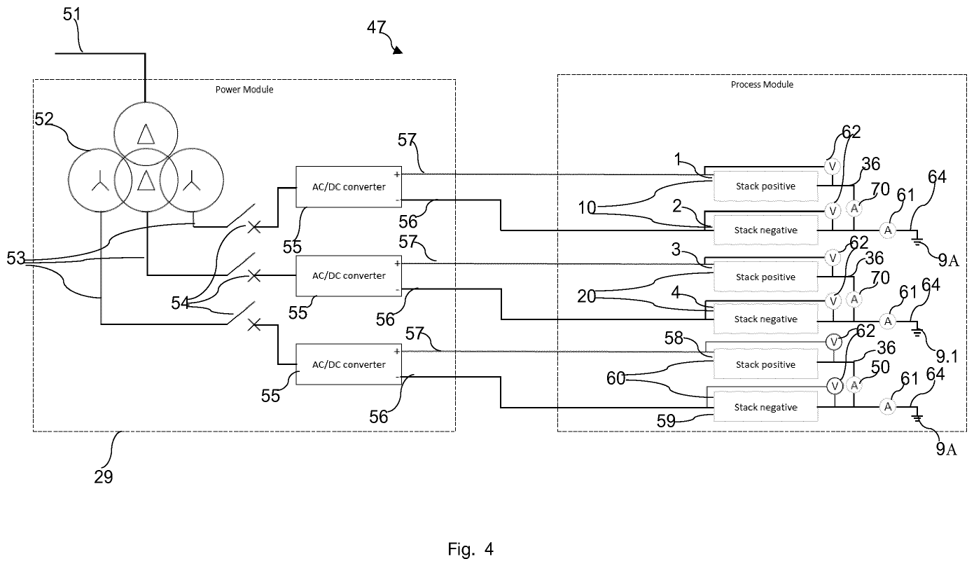

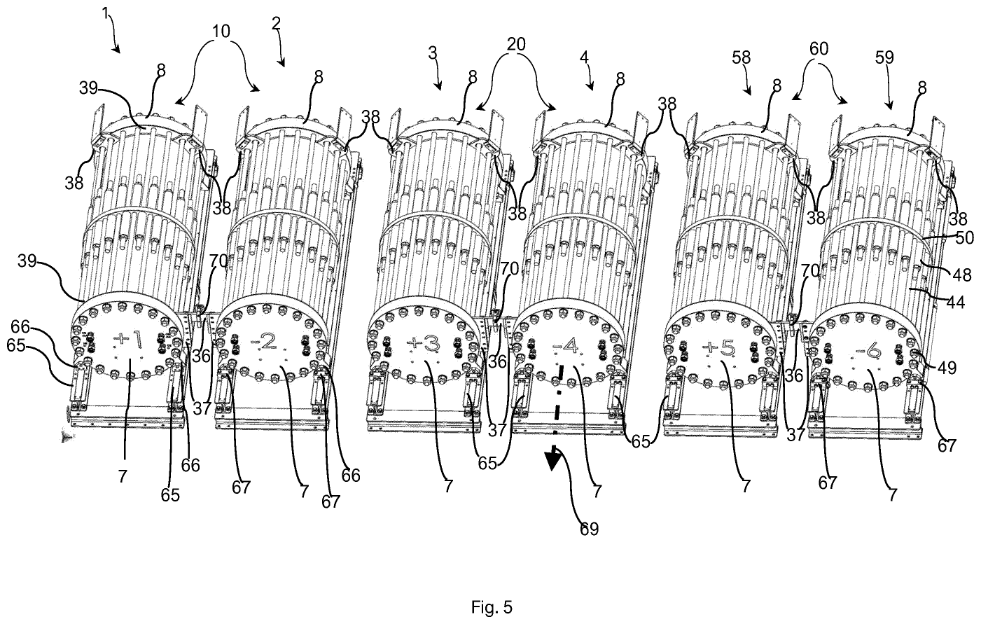

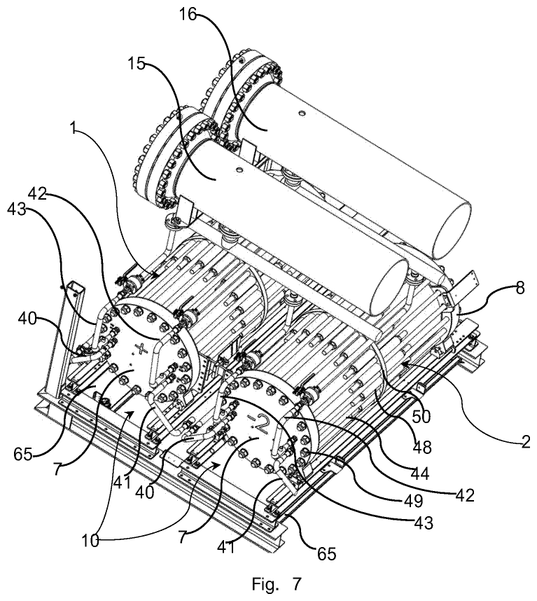

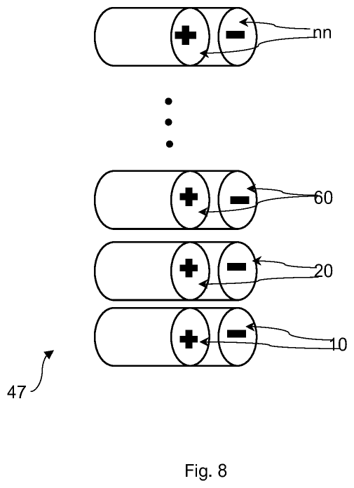

In FIG. 1 cell stack 1, cell stack 2, cell stack 3, and cell stack 4 are schematically shown. Cell stack 1 and cell stack 2 constitutes a first cell stack pair 10, and cell stack 3 and cell stack 4 constitutes a second cell stack pair 20. Any number of cell stack pairs are possible with the setup in FIG. 1, and as seen in FIG. 4 and FIG. 5 a further cell stack pair 60 may be provided comprising two further cell stacks 58,59. Even if not shown, more cell stack pars may be provided in horizontal alignment or as seen in FIG. 8, in vertical alignment. In FIG. 8 no power supply 29 is indicated, however a power supply shall naturally be included in such an arrangement of cell stack pairs. In a unit 47 as shown in FIG. 4, and FIG. 5, one power transformer 52 serves all 6 cell stacks, and as disclosed in FIG. 1, all the cell stacks in the unit 47 are served by common gas separators 15, 16. In the sectional view in FIG. 7, the gas separators 15, 16 are also shown, and here they are provided above the cell stack pair 10.

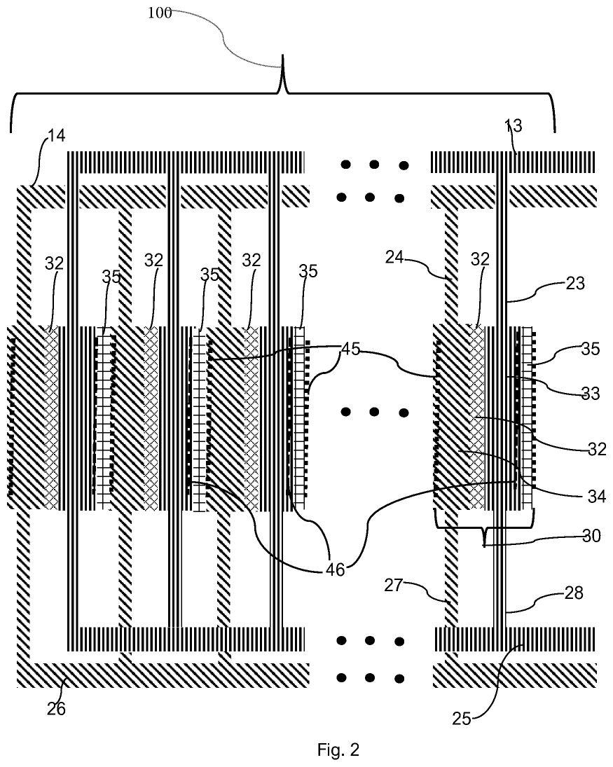

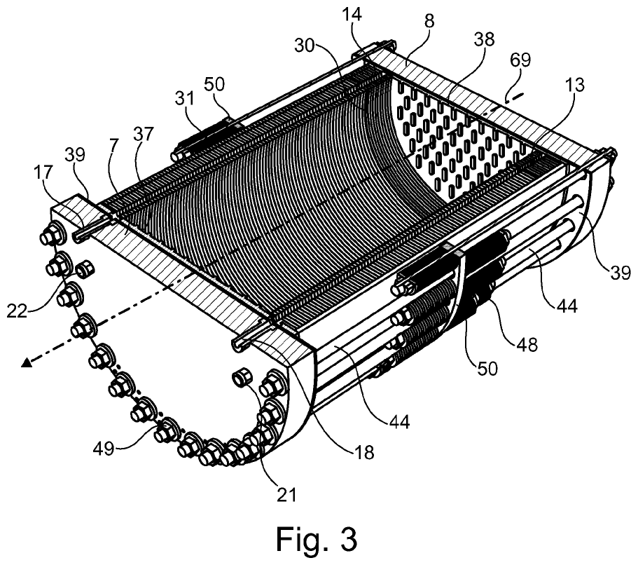

As seen in FIG. 3, in each cell stack 1,2,3,4,58,59 a range of individual cells 30 are arranged with cell frames 31 side by side and pressurised or urged against each other between two endplates 7,8. In FIG. 3 the internal parts of electrodes 45,46, bipolar plates 35 and diaphragms 32 belonging to each cell 30 are not disclosed, but these elements are schematically represented in FIG. 2.

In FIG. 2, it is schematically shown that in each cell 30, a diaphragm 32 is arranged and spans the area within the cell frame 31 (seen in FIG. 3). At a first side of the diaphragm 32, a catholyte flow volume or process chamber 33 allows a catholyte, piped through a cell internal catholyte flow channel 28, to immerse cathode 46 therein. The cathode 46 is connected to a bipolar plate 35. Similarly, at a second side of the diaphragm 32 an anolyte flow volume 34 allows an anolyte, piped through cell internal anolyte flow channel 27, to immerse an anode 45 therein. The anode is connected to a bipolar plate 35 however at a side opposite the side connected to the cathode. The anolyte flow channel 27 and the catholyte flow channel 28 are preferably shaped with additional flow resistances, such that a pressure drop remains from the stack internal manifolds 26, 25 and to the individual anolyte and catholyte reaction chambers 33, 34 or anolyte and catholyte flow volumes 33,34. This aids in ensuring that each cell 30 in the stack 1,2,3,4,58,59 receives the same amount of electrolyte irrespective of its position along the stack internal manifolds 25,26; 13,14.

On both anodic and cathodic sides of the bipolar plates 35, electrodes 45,46 with specialised surfaces are thus provided and are electrically in contact with respective sides of the bipolar plates 35 to enhance the production rates of O2 and H2. In FIG. 2, it is seen that the cathodic flow volume 33 is connected through a hydrogen and cell internal catholyte evacuation cannel 23 to a stack internal catholyte and hydrogen manifold 13.

The anodic flow volume 34 is connected through cell internal oxygen and anolyte evacuation channel 24 to a stack internal anolyte and oxygen manifold 14. The two manifolds 13, 14 are piped axially through the interconnection endplate 7 where they are connected to hydrogen and oxygen separation vessels 15, 16 respectively through respective gas drainpipe connections 18, 17 shown in FIG. 3 and indicated in FIG. 1. For ease of connection, the gas drainpipe connections 17, 18 run axially through the interconnection endplate 7 as seen in FIG. 3.

In the hydrogen separation vessel 15, catholyte and hydrogen will enter at a high point in the vessel, and from a lower part of this vessel, a catholyte stack external supply line 40 is arranged in order to feed hydrogen depleted catholyte back into the stacks 1, 2, 3, 4, 58, 59. A catholyte pump 5 is arranged therefore and if needed, the catholyte is cooled on the way in a catholyte heat exchanger 11. Water (not shown) is added to replenish what has been turned into oxygen and hydrogen and lastly, the catholyte is piped axially through the interconnection endplate 7 by catholyte endplate connection 21 as also seen in FIG. 3.

As seen in FIG. 2, in the stacks the cooled and water replenished catholyte is entered into an electrolyte stack internal manifold 25 through the endplate connection 21 and through individual catholyte flow channels 28 and into the individual cells 30 into the catholyte flow volume 33 to conclude the catholyte circulation.

Similarly, in the oxygen separation vessel 16, anolyte and oxygen will enter at a high point. From a lower part of the oxygen separation vessel 16, the oxygen depleted anolyte is extracted and fed back into the stacks 1, 2, 3, 4, 58, 59. Under the way, the anolyte is cooled in a heat exchanger 12, and water is added to replenish the water which has been electrolysed and turned into O2 and H2. By way of the anolyte pump 6, the anolyte is entered into the stack through the interconnection endplate 7 in axial channels 22. In the stacks 1,2,3,4, 58,59 the anolyte is piped through a stack internal anolyte manifold 26, through individual cell internal anolyte flow channels 27, into the individual cells 30, and into the anolyte volume 34 to thereby conclude the anolyte flow circuit.

The diaphragm 32 which separates the catholyte flow volume 33 from the anolyte flow volume 34 is not a fluid tight barrier but is more of a screen with a multitude of tiny orifices. The construction ensures, that gas bubbles formed at each their side of the screen or diaphragm 32 shall not venture therethrough but remain at the electrode side at which they were produced and exit the catholyte and hydrogen evacuation channel 23 and the anolyte and oxygen evacuation channel 24 respectively. The tiny orifices of the diaphragm 32 shall fill up with lye and allow transport of ions which needs to pass between cathode and anode to facilitate the electrolytic action. In FIG. 2 the bipolar plates 35 and diaphragms 32 are also schematically indicated.

As seen in FIG. 1, the catholyte lye pump 5 supplies the catholyte to both stacks 1,2 in first cell stack pair 10 and cell stacks 3,4 in the second cell stack pair 20. This is achieved through a catholyte stack external supply line 40, which has a manifold character and branches out to feed each cell stack 1, 2, 3, 4, 58, 59.

Similarly, the anolyte lye pump 6 supplies the anolyte to both stacks 1,2 and 3,4 (and 58,59) in cell stack pair 10, 20, (and 60). This is achieved through anolyte stack-external supply 41, which has a manifold character and branches out to feed each of the cell stacks 1, 2, 3, 4 58, 59. The lye electrolyte pumps 5,6 and separation vessels 15, 16 may serve more than the shown two (three or more cell stack airs) cell pairs 10, 20, 60. It is preferred that op to three cell stack pairs with a total of six stacks are provided and served by one pair of gas separators and accompanying pumps.

Also, in FIG. 1 an anolyte and oxygen gas stack-external exit line 42 is seen, which has manifold character, and unifies the exit oxygen gas from the four stacks 1, 2, 3, 4 into one stream, which feeds into the oxygen separation vessel 16. And similarly, the catholyte and hydrogen gas stack-external exit line 43 is seen, which has manifold character and unifies the exit hydrogen gas from the four stacks 1, 2, 3, 4 into one stream, which feeds into the hydrogen separation vessel 15. In the FIG. 4 and FIG. 5 embodiment, similarly one anolyte and one catholyte pump shall serve all stacks 1, 2, 3, 4,58, 59.

Thus, the stacks 1,2,3,4, 58,59 in pairs of stacks 10, 20, 60 share the same separation vessels 15,16, pumps 5,6, and further an electrical lead 19 to a zero potential connection point 9 is arranged at the separation vessels. Also, the leads 36 between the current injection electrodes 37,38 at the interconnection end plates 7,8 have each their connection to zero potential 9A shown both in FIG. 1, FIG. 4 and FIG. 5. It is to be noted, that the electrolyte is electrically conductive to some extend, and that by the lead 19, the current injection electrode 37 in each stack residing adjacent to the interconnection end plate 7 shall also be connected to the zero potential or ground 9A. Between the first current injection electrodes 37 at the interconnection endplates 7 in the stacks 1,2 in a first stack pair 10, an electric interconnection lead 36 is provided. Further, between the current injection electrodes 37 at the interconnection endplates 7 in the stacks 3,4 in a second stack pair 20, an electric lead 36 is provided. And similarly, a seen in FIGS. 5 and 4 also the stack pair 60 shall have their current injection electrodes at the interconnection endplates interconnect by an interconnection lead 36. The leads 36 between the first current injection electrodes 37 (FIG. 3) in the first stack pair 10 and in the second stack pair 20 as well as in the third stack pair 60, are instrumental in supplying the current running through both stacks in each pair and thus must be prepared to carry a heavy current low without causing any voltage loss. As seen, each of these leads 36 are also connected to ground 9A through a ground connection lead 64.

As seen in FIG. 4 and FIG. 5 in each cell stack pair 10, 20, 60 the electrodes residing most distal from the interconnection endplates 8, namely the second current injection electrodes 38 are connected to electrical potentials equally higher and lower over the electrical potential arranged at the first current injection electrodes 37. As seen in FIGS. 1 and 4, this is cone via low potential DC connection line 56 and high potential DC connection line 57.

In the embodiment illustrated in FIG. 1, the cell stacks 1, 2 and 3, 4 in a pair of stacks 10,20 are connected to each their power supply, but a common power supply can alternatively be used. Two cell stack pairs 10, 20 are shown in FIG. 1, but more cell stack pairs may be provided according to the available power and desired hydrogen production.

In FIG. 3, an insulation plate 39 is shown between the first current injection electrodes 37 and the interconnection endplate 7. A similar insulation plate 39 is shown between the second current injection electrode 38 and the distal endplate 8. These two plates 39 ensures, that any potential residing at the electrodes 37, 38 is not carried also by the endplates 7, 8. In FIG. 3, the pull rods 44 are also shown along with nuts 49 provided externally at each endplate 7,8. In the disclosed embodiment, the disc spring stacks 48 are shown at a midplane for the stack where they may be provided owing to the use of a mirror force ring 50. The mirror force ring 50 allows stacks to be arranged in proximity of each other, or closer to wall parts, as the disc spring stacks 48 will not cause long protrusions of the pull rods 44 away from the interconnection endplates 7 or distal endplates 8. This allows a smaller footprint of the entire plant comprising 3 or more pairs of stacks. It is also instrumental in keeping the connection endplates and the distal endplates free of the disc spring stacks, such that the fluid flow connection to/from the stack and electric high and low potential connections to the current injection electrodes 37,38 are not hampered by the disc spring stacks.

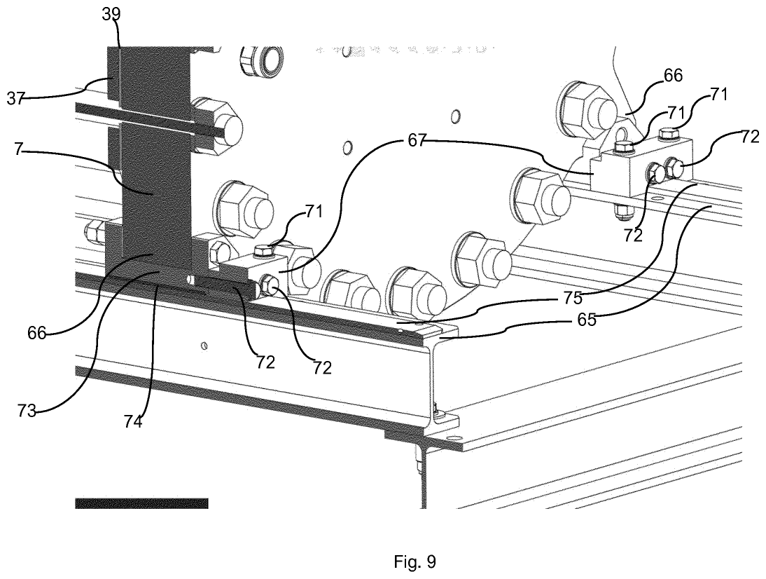

During use, a somewhat elevated temperature and high internal pressure in the catholyte and anolyte will change the length dimension of the stacks, as the pull roods 44 are essentially elastic in nature and the cell frames also expand during heating. In order to ensure, that the high pressure fluid flow connections 22, 21,17,18 are always in the same place, it is preferred to arrest the interconnection endplates, while the distal endplates are allowed to move in the stack length direction 69 (indicated in FIG. 4 and FIG. 5) to mitigate heat and pressure induced extension of the stack. This is achieved in that each stack 1,2,3,4,58,59 rests on tracks 65 by way of downwardly directed supports 66 at both the interconnection end plates 7 and the distal end plates 8, however such that the interconnected endplates have the supports 66 bolted onto the tracks through arresting blocks 67. The arresting blocks 67 are bolted onto both the end plate supports 66 and onto the tracks 65. As seen in FIG. 9, the supports 66 are comprised of protrusion of the endplates 7 and of shoe like elements 73 embracing the protrusions and bolt fixated thereto, and further fitting onto raised centre portions of the tracks 65. Two vertical bolts 71 arrests the arresting blocks to the tracks 65 and two horizontal bolts 72 secures the arresting block 67 against the shoe like element 73. The shoe like element 73 may be secured to all supports, and aids in securing movability of the distal endplate 8, as they comprise skate pieces 74 adapted to slide on the raised portions 75 of the track 65. Thereby the interconnection endplate 7 is effectively arrested in the length axis direction 69 of the stack and the distal endplate is allowed movability as no arresting blocks are arranged at the distal endplates.

The movement of the distal endplates 8 shall easily be absorbed by the power lines attached to the current injection electrodes residing in close proximity thereto. The power lines (not shown) even if quite thick, are not sensitive to minor deformations as are the less flexible metal pipes 43,40,42,41 used for the supply of the liquids at the interconnection end plates 7. It is possible to supply the fluids to the stacks through flexible hoses, but safety and reliability issues make this type of connection to the stacks less desirable, an issue which will grow as the pressure at which the hydrogen producing plants are designed to operate will increase in the future. At present design pressures at 30-50 bars are used, however pressures up to 150 bars are also under consideration.

In FIG. 4 a schematic electrical connection diagram is shown with power input from a high voltage three phase AC grid line 51 which supplies the power to three pairs of stacks 10, 20, 60. This is done in that a power transformer 52 in power supply unit 29 transforms the three-phase AC input power 51 to three output AC lines 53 each comprising three phases. Each of these lines 53 are, through electric switching devices 54, coupled to each their AC/DC converter 55. From each AC/DC converter, high and low DC potential lines 56, 57 are connected to each their end of a stack 1, 2, 3, 4, 58, 59 in a stack pair 10, 20, 60. The two stacks in each stack pair 10, 20, 60 are interconnected at opposite ends thereof through the interconnection leads 36, and at the interconnection leads 36 the stacks are further connected to zero potential or earth (TERRA) 9A.

Further seen in FIG. 4. are voltage measuring devices 62, which are connected to each their DC current supply potential of each stack, such that the potential loss V between the current injection electrodes 37, 38 is measured in all stacks. Also, two current measurement devices 70, 61 are indicated. The current measurement device 70 is adapted to measure the current running between the stacks in each stack pair in lead 36, whereas current measurement device 61 observe any current flow between the lead 36 and the earth connection 9A.

In both FIG. 4 and FIG. 5 the stacks 1, 2, 3, 4, 58, 59 are aligned side by side and not end to end as shown in FIG. 1. This configuration has advantages, as the electric leads 36 becomes very short and does not need to protrude axially out from the interconnection endplates 7 arranged here. In a setup with three cell stack pairs as shown in FIG. 4, or FIG. 5 all of the fluid connections will remain as disclosed and described with respect to FIGS. 1, 2 and 3, while the electric supply is different as the FIGS. 4 and 5 embodiment with all stacks aligned with all their interconnection endplates 7 and all of distal endplates 8 abutting each their vertical planes, the power supply lines with high and low potential need not circumvent or travers the stack external manifold piping. Also, from a perspective of servicing stacks, such as to exchange individual stacks, the embodiment with all stacks aligned side by side as disclosed in FIGS. 4 and 5 are preferred, as access to interconnection and distal end plates is easier in such a configuration.

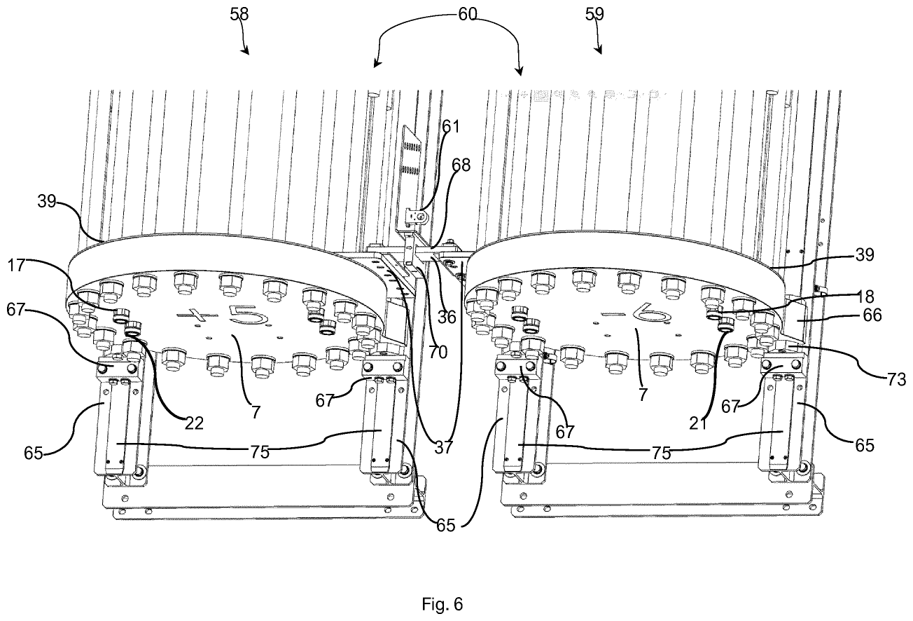

As seen in FIG. 6, the current measurement device 61 may be provided at the grounding lead 64 (the lead 64 is indicated in FIG. 3 but not shown in FIG. 5). The optional current measurement device 70 is indicated in the lead 36 between the current injection electrodes 37 of stack pairs 10, 20 60. As also indicated in FIG. 6, the lead 36 between the current injection electrodes at the earthed end of a stack pair has a fishplate like and sturdy appearance which along with its manufacture in a low resistance metal shall ensure no or only very small resistances between the two current injection electrodes 37 of a stack pair residing at the interconnection end plate 7.

This arrangement of the stacks in side by side manner, allows for a reduced footprint, as only little space is needed between the stacks. At the same time, the hight potential connection may all reside an opposed end to the low potential interconnections, and this is advantageous from safety and security reasons, not least as the piping may reside mainly with the interconnection end plate 7, and in this way shall not interfere with the high and low potential connections 56,57 to the stack pairs 10, 20, 60.

An arrangement of stack pairs in vertical alignment is seen in FIG. 8. A power module to supply direct current may be positioned next to the array. Preferably the earthed current injection electrodes shall all be provided at interconnection endplates and arranged in one and the same vertical plane. Similarly current injection electrodes 38 to be served with a high (+) electric direct current potential are arranged above each other and current injection electrodes 38 to be served with a low (−) electric direct current potential are also arranged one above the other as seen in FIG. 8. Endplates 7,8 are not indicated separately, but the stacks with endplates are shaped as shown in FIG. 6 and FIG. 9 and shall comprise track mounting means and arresting means to assure, that the interconnection endplates 7 are not allowed to move during electrolysation while distal endplates 8 are allowed a degree of movement in the stack axis direction 69.

It is to be noted that the figures and the above description have shown the example embodiments in a simple and schematic manner. Many of the specific mechanical details have not been shown since the person skilled in the art should be familiar with these details and they would just unnecessarily complicate this description.

### LIST OF PARTS

1 cell stack No. 1
2 cell stack No. 2
3 cell stack No. 3
4 cell stack No. 4
5 catholyte pump
6 anolyte pump
7 interconnection endplate
8 distal endplate
9 zero potential connection
9A zero potential connection at first current injection electrode
10 first cell stack pair
11 catholyte heat exchanger
12 anolyte heat exchanger
13 catholyte and hydrogen manifold
14 anolyte and oxygen manifold
15 hydrogen separation vessel
16 oxygen separation vessel
17 axially through-going gas and electrolyte outlet connection
18 axially through-going gas and electrolyte outlet connection
19 electrical lead
20 second cell stack pair
21 axially through-going electrolyte inlet connection
22 axially through-going electrolyte inlet connection
23 cell internal catholyte and hydrogen evacuation channel
24 cell internal anolyte and oxygen evacuation channel
25 stack internal catholyte manifold
26 stack internal anolyte manifold
27 cell internal anolyte flow channel
28 cell internal catholyte flow channel
29 power supply unit
30 individual cell
31 cell frame
32 diaphragm
33 catholyte flow volume and process chamber
34 anolyte flow volume and process chamber
35 bipolar plate
36 interconnection lead
37 first electric current injection electrode
38 second electric current injection electrode
39 insulation plate
40 catholyte stack external supply line
41 anolyte stack external supply line
42 anolyte and oxygen gas, stack external exit line
43 catholyte and hydrogen gas, stack external exit line
44 pull rods
45 anode
46 cathode
47 electrolyser unit
48 disc spring stack
49 nut
50 mirror force ring
51 three phase AC grid line
52 power transformer
53 Three phase output AC lines
54 electric switching devices
55 AC/DC converter
56 low potential line
57 high potential line
58 cell stack of third cell stack pair
59 cell stack of third cell stack pair
60 third cell stack pair
61 Current measurement device
62 Voltage measurement device
63 Control power supply
64 Ground connection lead
65 Tracks
66 Downwardly directed supports
67 Arresting blocks
68 Fish plate electric current conductor
69 Length axis direction
70 Optional current measurement device
71 Vertical bolts
72 Horizontal bolts
73 Shoe like element
74 Skate pieces
75 Raised portions of the tracks
100 cells in stack
nn multiple cell stack

1-12. (canceled)

13. An electrolyser unit comprising:
a plurality of individual electrolyser stacks, wherein each individual electrolyser stack has a series of cell circumferential cell frames configured for being urged against each other between an interconnection endplate and an opposed distal endplate, wherein each cell includes:
a diaphragm spanning the cell frame;
electrodes;
a catholyte flow channel;
an anolyte flow channel;
a catholyte and hydrogen evacuation channel; and
an anolyte and oxygen evacuation channel;
wherein the cell frames are configured for securing the alkaline electrolyte and gasses within the cell under elevated pressure when pressed against adjacent circumferential cell frames;
wherein the interconnection endplate of each individual cell stack includes:
an axially through-going hydrogen gas and electrolyte connection which is in fluid communication with a hydrogen separation vessel and an axially through-going oxygen gas and electrolyte connection which is in fluid communication with an oxygen separation vessel; and
axially through-going electrolyte flow channels which are in fluid communication with electrolyte pumps;
wherein at least a pair of electrolyser stacks are provided and arranged pairwise adjacent each other;
wherein in each pair of stacks, first current injection electrodes provided at each interconnection endplate are electrically interconnected and connected to a common electrical zero potential and second current injection electrodes, at each of the distal endplates, are connected to electric power supply at potentials equally higher and lower than the electrical zero potential realised at the electrodes at the interconnection endplates, and in that stack pairs are further connected to common hydrogen and oxygen separation vessels and electrolyte supply pumps through their interconnection endplates.

14. The electrolyser unit according to claim 13, wherein in the interconnection end plates of a stack pair or of a multitude of stack pairs are arrange adjacent to a common vertical plane and immovably locked to support tracks, and wherein the distal endplates are movably arranged on the support tracks to allow the distal endplates a degree of movement in a length axis direction of the stack it belongs to.

15. The electrolyser unit according to claim 13, wherein at least one of a voltage measurement device configured to capture the voltage signal V over each stack and a current measurement device configured to capture the current signal A in each ground connection lead are arranged such that at least one of the current and the voltage are captured and stored regularly during electrolysation.

16. The electrolyser unit according to claim 13, wherein a current supply device is provided for each pair of interconnected electrolyser stacks or in that a common current supply is provided for the entire multitude of pairs of interconnected electrolyser stacks.

17. The electrolyser unit according to claim 13, wherein a power transformer is adapted to supply power to each of three pairs of stacks by firstly splitting a three phase electric AC grid power input in a power transformer into three identical three phase output AC lines, and provide three AC to DC converters adapted to convert each of the three phase output AC lines into three corresponding DC high potential and low potential lines, and provide a high potential output and low potential output of each DC line output in conductive connection with the respective second ones of the two current injection electrodes placed at distal endplates of each stack, while an electrical interconnection of each of the current injection electrodes at the interconnection endplates at each stack pair is provided by interconnection leads whereby further, these interconnection leads are connected to the zero potentials trough ground connection leads.

18. A method for supplying pairs of electrolyser stacks with alkaline electrolyte, electric current and gas drain piping, comprising, for each pair of electrolyser stacks:
supplying, through interconnection endplates, alkaline electrolyte at elevated pressure through common electrolyte supply pipes;
draining off, through the interconnection endplate, oxygen gas containing electrolyte, and hydrogen gas containing electrolyte, to common gas separation vessels for oxygen and hydrogen respectively;
pulling first electrically interconnected current injection electrodes at interconnection endplates to zero electrical potential, through ground connection leads; and
supplying second current injection electrodes belonging to stack pairs and placed at distal endplates of each stack with electric current at potentials equally higher and lower respectively than the zero potential at the first current injection electrodes.

19. The method according to claim 18, wherein the interconnection endplates of a pair of stacks during use are urged towards respective distally placed endplates through a number of pull rods attached to the interconnection endplates and the distal endplates respectively and arranged externally to perimeters of the cells frames in the stacks such that cell frames between the interconnection endplates and the distal endplates are pressed towards each other.

20. The method according to claim 18, wherein a multitude of electrolyser pairs are supplied with electric current from each their electric power supply or through a common current supply device.

21. The method according to claim 18, wherein an anolyte pump supplies anolyte drained from the oxygen separation vessel to respective anolyte endplate connections of each stack through anolyte stack external supply lines and that a catholyte pump supplies catholyte drained from the hydrogen separation vessel to respective catholyte endplate connections of each stack through catholyte stack external supply lines.

22. The method according to claim 18, wherein interconnection end plates of a stack pair or of a multitude of stack pairs are arrange adjacent to a common vertical plane and are immovably locked to support tracks, and that the distal endplates are movably supported by the tracks to allow the distal endplates a degree of movement in a length axis direction of respective stacks.

23. The method according to claim 18 wherein a power transformer supplies power to each of three pairs of stacks by firstly splitting a three phase electric AC grid line input into three identical three phase output AC lines, and secondly converting each of the three phase output AC lines into three corresponding DC high potential and low potential lines in separate AC to DC converters, and thirdly directs a high potential output and low potential output of each DC line output to the respective second ones of the two current injection electrodes placed at distal endplates of each stack of the pair of stacks, while electrically interconnecting each of the current injection electrodes at the interconnection endplates and ensure a ground potential at the interconnection endplates by a ground connection lead to zero potential.

24. The method according to claim 18, wherein at least one of a voltage measurement device adapted to capture the voltage signal V over each stack and a current measurement device adapted to capture the current signal A in each ground connection lead are arranged such that at least one of the current A and the voltage are captured and stored regularly during electrolysation.
